(19) United States
(12) Patent Application Publication
(10) Pub. No.: US 2011/0168458 A1
(43) Pub. Date: Jul. 14, 2011

(54) Detecting apparatus of capacitive touch panel and the method therefor

(75) Inventors: Hung-Yi Lin, Hsin Tien (TW); Yen-Chang Tung, Hsin Tien (TW)

(73) Assignee: IdeaCom Technology Corporation, Hsin Tien (TW)

(21) Appl. No.: 12/659,748

(22) Filed: Mar. 19, 2010

(30) Foreign Application Priority Data
Jan. 13, 2010 (TW) 099100802

(51) Int. Cl. G06F 3/044

(52) U.S. Cl. 178/18.06

(57) ABSTRACT

The invention relates to a detecting apparatus of a capacitive touch panel for detecting at least one touched position executed by a user on the capacitive touch panel including a plurality of sensing elements. The detecting apparatus comprises a first detecting module, a judging module, a second detecting module and a determining module. The first detecting module detects the plurality of sensing elements to generate a plurality of first detecting signals. The judging module generates a plurality of judging signals according to the plurality of first detecting signals. The second detecting module detects at least one sensing element of the plurality of sensing elements according to the plurality of judging signals to generate at least one second detecting signal. The determining module determines the at least one touched position executed by the user on the capacitive touch panel according to the at least one second detecting signal.

### BACKGROUND OF THE INVENTION

1. Field of the Invention

The invention is related to a detecting apparatus of a capacitive touch panel and the method therefor, and more specifically related to a detecting apparatus of a capacitive touch panel and the method therefor for detecting multi touch points executed on the capacitive touch panel by the user.

2. Description of the Prior Art

Various kinds of touch sensing technology are used in many different electronic products in recently years for its progress in better quality and more convenient. A touch panel is implemented in various kinds of electronic products because it has advantages in size small, cost less, power low and life durable.

Touch panels can be divided into resistive touch panel, capacitive touch panel, optical touch panel and other various kinds of touch panels. Conventional resistive touch panels only detect single touch operation but not multi touch operation executed by the user because the limitation of the structure therein. Resistive touch panels will detect the multi touch operation executed by the user incorrectly.

Therefore, capacitive touch panel is developed to improve the limitation of the resistive touch panel. The detecting manner of conventional capacitive touch panel scans every sensing element (sensing trace), determines the touched position on the capacitive touch panel executed by the user operated via finger or stylus according to capacitance value generated by scanning those sensing elements. Due to the sensing elements are independent to each other, the capacitive touch panel has the ability of detecting multi touch operation executed by the user. Therefore, the capacitive touch panels are implemented into various kinds of electronic products with the application of multi touch operation.

Furthermore, capacitive touch panels can be divided into self capacitive touch panel and mutual capacitive touch panel by detecting manner. The detecting manner of the self capacitive touch panel charges and discharges at the same terminal of one of the sensing elements of the capacitive touch panel to detect whether the sensing element has been touched by the user or not. The advantage of the detecting manner of the self capacitive touch panel is fast detecting the touched position but it has the disadvantage in detecting the absolute position of the touch operation executed by the user incorrectly. Accordingly, the detecting manner of the self capacitive touch panel has limitation of application because it cannot detect the absolute position of the touch operation executed by the user. The detecting manner of the mutual capacitive touch panel is inputting signals to one terminal of a first sensing element, detecting the output signal from one terminal of a second sensing element crossed to the first sensing element and then determining the absolute position of the touch operation executed by the user according to the detected output signal. However, the detecting manner of the mutual capacitive touch panel wastes more time and power than the detecting manner of the self capacitive touch panel because it needs to detect more sensing elements.

According to the defects of the prior arts described above, how to provide a detecting apparatus of a capacitive touch panel and the method therefor for fast scanning the sensing elements of the capacitive touch panel and accurately determining the touched position of the touch operation executed by the user is an important matter in developing the capacitive touch panel technology.

### SUMMARY OF THE INVENTION

It is therefore a primary objective of the present invention to provide a detecting apparatus of a capacitive touch panel and a method therefor suited in a capacitive touch panel for detecting the touched position of touch operation executed by a user. The invention has advantages in fast, power low and further enhances the efficient of the capacitive touch panel.

One embodiment of the present invention provides a detecting apparatus of a capacitive touch panel for detecting at least one touched position of a touch operation executed by a user on the capacitive touch panel including a plurality of sensing elements. The detecting apparatus of a capacitive touch panel comprises a first detecting module, a judging module, a second detecting module and a determining module. The first detecting module detects the plurality of sensing elements of the capacitive touch panel to generate a plurality of first detecting signals. The judging module coupled to the first detecting module generates a plurality of judging signals according to the plurality of first detecting signals. The second detecting module coupled to the judging module and the capacitive touch panel detects at least one sensing element of the plurality of sensing elements according to the plurality of judging signals to generate at least one second detecting signal. The determining module coupled to the second detecting module determines the at least one touched position of the touch operation executed by the user on the capacitive touch panel according to the at least one second detecting signal.

The present invention further discloses a detecting method of a capacitive touch panel for detecting at least one touched position of a touch operation executed by a user on the capacitive touch panel including a plurality of sensing elements, which comprising following steps: (a) detecting the plurality of sensing elements of the capacitive touch panel to generate a plurality of first detecting signals correspondingly; (b) generating a plurality of judging signals according to the plurality of first detecting signals; (c) detecting at least one sensing element of the plurality of sensing elements according to the plurality of judging signals to generate at least one second detecting signal; and (d) determining the at least one touched position of the touch operation executed by the user on the capacitive touch panel according to the at least one second detecting signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an embodiment of a detecting apparatus of a capacitive touch panel according to the present invention.

FIG. 2 is a schematic diagram of an embodiment of a detecting manner of the detecting apparatus of a capacitive touch panel according to the present invention.

FIG. 3 is a flowchart diagram of an embodiment of a detecting method of a capacitive touch panel according to the present invention.

### DETAILED DESCRIPTION

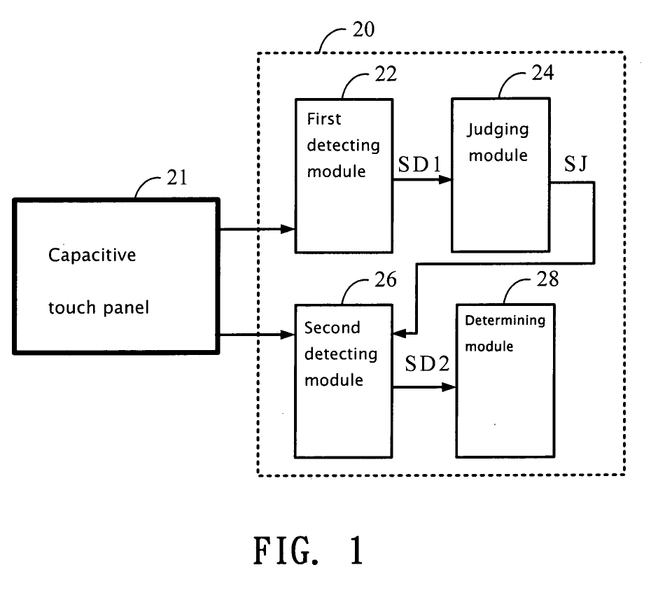

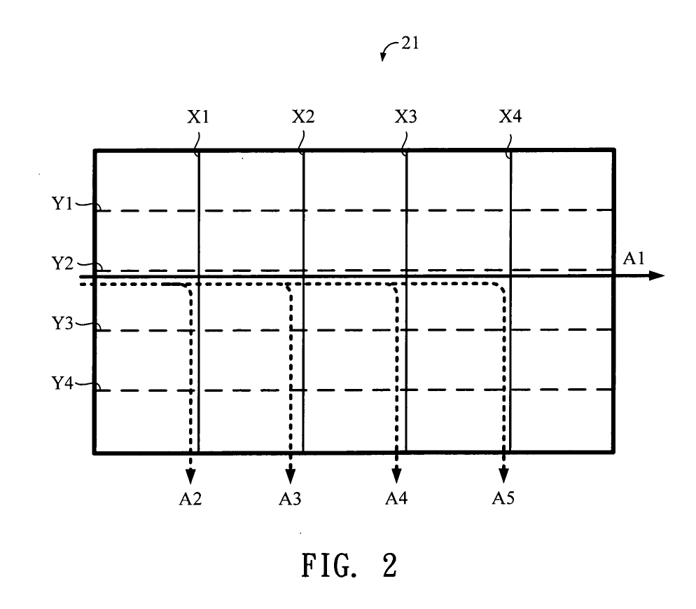

Please refer to FIGS. 1 and 2. FIG. 1 is a schematic diagram of an embodiment of a detecting apparatus of a capacitive touch panel according to the present invention. FIG. 2 is a schematic diagram of an embodiment of a detecting manner of the detecting apparatus of a capacitive touch panel according to the present invention. As shown in FIGS. 1 and 2, the present invention provides a detecting apparatus 20 of a capacitive touch panel 21 for detecting at least one touched position of a touch operation executed by a user on the capacitive touch panel 21 including a plurality of sensing elements (X1˜X4, Y1˜Y4). The detecting apparatus 20 of a capacitive touch panel 21 comprises a first detecting module 22, a judging module 24, a second detecting module 26 and a determining module 28. The first detecting module 22 is used for detecting the plurality of sensing elements (X1˜X4, Y1˜Y4) of the capacitive touch panel 21 to generate a plurality of first detecting signals SD1 correspondingly. The judging module 24 coupled to the first detecting module 22 is used for generating a plurality of judging signals SJ according to the plurality of first detecting signals SD1. The second detecting module 26 coupled to the judging module 24 and the capacitive touch panel 21 is used for detecting at least one sensing element of the plurality of sensing elements (X1˜X4, Y1˜Y4) according to the plurality of judging signals SJ to generate at least one second detecting signal SD2. The determining module 28 coupled to the second detecting module 26 is used for determining the at least one touched position executed by the user on the capacitive touch panel 21 according to the at least one second detecting signal SD2.

The judging module 24 is used for judging which of the plurality of sensing elements (X1˜X4, Y1˜Y4) has been touched by the user according to the plurality of first detecting signals SD1 and generates a plurality of judging signals SJ according to corresponding judged results. The second detecting module 26 is used for detecting the at least one sensing element touched by the user according to the plurality of judging signals SJ to generate the at least one second detecting signal SD2.

The plurality of sensing elements (X1˜X4, Y1˜Y4) include a first sensing element set (X1˜X4) and a second sensing element set (Y1˜Y4), and the first sensing element set (X1˜X4) is interlaced to the second sensing element set (Y1˜Y4). In one embodiment, the first sensing element set (X1˜X4) is perpendicular to the second sensing element set (Y1˜Y4) approximately. The first detecting module 22 is used for detecting the first sensing element set (X1˜X4) or the second sensing element set (Y1˜Y4) to generate the plurality of first detecting signals SD1. In one embodiment, the first detecting module 22 detects the capacitive touch panel 21 by the detecting manner of conventional self capacitive touch panel which inputs signals to one terminal of a sensing element at a terminal and then detects the signal from the same terminal to generate the one of the plurality of first detecting signals SD1.

In another embodiment, the first detecting module 22 detects one sensing element of the first sensing element set (X1˜X4) or the second sensing element set (Y1˜Y4) as shown as arrow A1 in FIG. 2. Therefore, the first detecting module 22 detects only one sensing element of the first sensing element set (X1˜X4) or the second sensing element (Y1˜Y4) to generate the plurality of first detecting signals SD1. The judging module 24 judges which of the plurality of sensing element (X1˜X4, Y1˜Y4) has been touched by the user according to the first detecting signals SD1.

When the judging module 24 determines which of the plurality of sensing element (X1˜X4, Y1˜Y4) has been touched, the second detecting module 26 detects the same sensing element correspondingly to determine the absolute position of the touch operation executed by the user on the sensing element of the capacitive touch panel 21. In the embodiment, the determining module 28 determines at least one absolute position of the touch operation executed by the user on the capacitive touch panel 21. The second detecting module 26 is used for detecting the first sensing element set (X1˜X4) and the second sensing element set (Y1˜Y4) to generate the at least one second detecting signal SD2. The detecting manner of the second detecting module 26 is the same as the detecting manner of mutual capacitive touch panel. The detecting manner inputs signals to one sensing element of the first sensing element set (X1˜X4) or second sensing element set (Y1˜Y4) and then detects signals from one terminal of one sensing element of another sensing element set to generate the at least one second detecting signal SD2.

Furthermore, in one embodiment, assuming the judging module 24 judges the sensing element Y2 of the second sensing element set (Y1˜Y4) has been touched by the user according to the first detecting signal SD1, the second detecting module 26 only executes the operation for detecting the sensing element Y2 of the capacitive touch panel 21. The detecting manner is as shown as the arrows A2˜A5 which respectively input signals to one terminal of the sensing element Y2 of the second sensing element set (Y1˜Y4) and then detects signals from terminals of the sensing elements of the first sensing element set (X1˜X4) crossed to the sensing element Y2 and then generates the at least one second detecting signal SD2 correspondingly. Therefore, the second detecting module 26 must detect both the first sensing element set (X1˜X4) and the second sensing element set (Y1˜Y4) to generate the at least one second detecting signal SD2.

Due to the determining module 28 is used for determining the absolute position of the touched position by the user, when the judging module 24 judges which sensing element has been touched by the user according to the plurality of first detecting signals SD1 generated by the first detecting module 22, the second detecting module 26 executes the operation for detecting sensing elements of another sensing element set crossed to the sensing element judged by the judging module 24 to determine the absolute position of the touch operation executed by the user. Please refer to FIG. 2, if the first detecting module 22 detects the sensing element Y2 of the second sensing element set (Y1˜Y4) has been touched by the user, the second detecting module 26 further detects sensing elements X1˜X4 of the first sensing element set X1˜X4 crossed to the sensing element Y2 of the second sensing element set (Y1˜Y4) as shown as the arrows A2˜A5 in FIG. 2. Furthermore, the second detecting module 26 transmits the detecting signals generated from sensing element X1˜X4 to the determining module 28 for determining the absolute position respectively, the detecting signals are the second detecting signals SD2 in this embodiment.

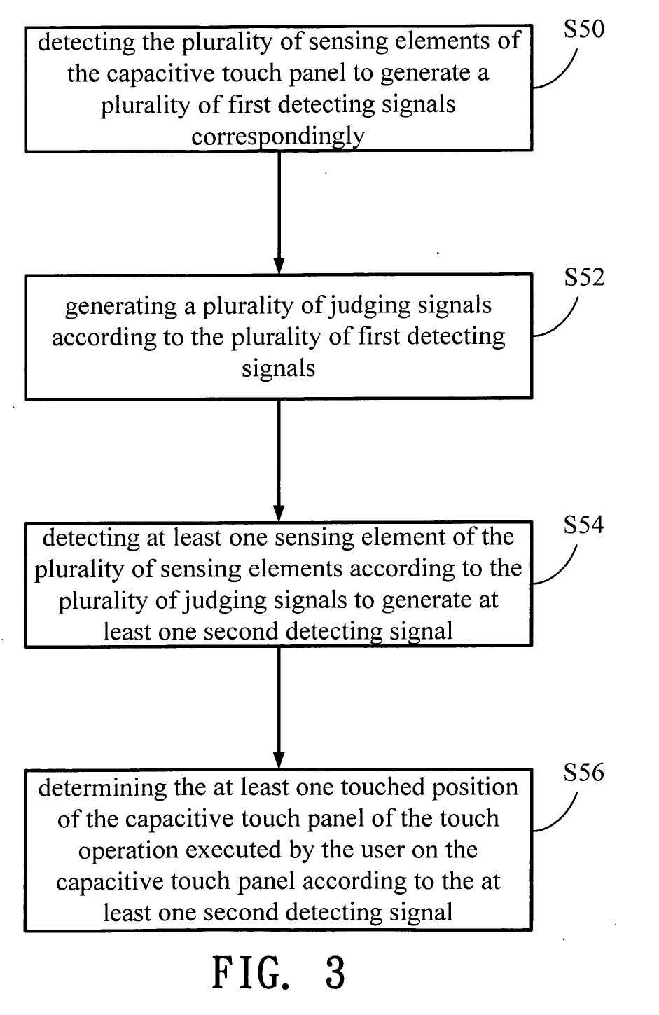

Please refer to FIG. 3. FIG. 3 is a flowchart diagram of an embodiment of a detecting method of a capacitive touch panel according to the present invention. As shown in FIG. 3, another embodiment of the present invention provides a detecting method of a capacitive touch panel for detecting at least one touched position of a touch operation executed by a user on the capacitive touch panel including a plurality of sensing elements, which comprising following steps:

Step 50: detecting the plurality of sensing elements of the capacitive touch panel to generate a plurality of first detecting signals correspondingly.

Step 52: generating a plurality of judging signals according to the plurality of first detecting signals. Wherein this step S52 judges which of the plurality of sensing elements has been touched by the user and generating a plurality of judging signals according to judged results correspondingly.

Step 54: detecting at least one sensing element of the plurality of sensing elements according to the plurality of judging signals to generate at least one second detecting signal. This step detects the at least one sensing element touched by the user according to the plurality of judging signals to generate the at least one second detecting signal.

Step 56: determining the at least one touched position of the capacitive touch panel of the touch operation executed by the user on the capacitive touch panel according to the at least one second detecting signal.

In one embodiment, the plurality of sensing elements include a first sensing element set and a second sensing element set. The first sensing element set is interlaced to the second sensing element set, and the first sensing element set is perpendicular to the second sensing element set approximately. The step S50 detects the first sensing element set or the second sensing element set to generate the plurality of first detecting signals. The step S54 detects both the first sensing element set and the second sensing element set to generate the at least one second detecting signal.

As mentioned above, the detecting apparatus of a capacitive touch panel first detects which of the sensing element has been touched by the user by the detecting manner of self capacitive touch panel and further detects the touched sensing element by the detecting manner of mutual capacitive touch panel to determine the absolute position of the touch operation executed by the user on the capacitive touch panel. The detecting apparatus of a capacitive touch panel of this invention provides a new style detecting manner of capacitive touch panel and has the advantages in fast detecting and has the ability of determining the absolute position. The detecting apparatus of a capacitive touch panel provides a fast, power low and accurate detecting manner in determining the absolute positions via the single touch operation or multi touch operation executed by the user on the capacitive touch panel.

Those skilled in the art will readily observe that numerous modifications and alterations of the apparatus and the method may be made while retaining the teachings of the invention. Accordingly, the above disclosure should be construed as limited only by the metes and bounds of the appended claims.

What is claimed is:

1. A detecting apparatus of a capacitive touch panel for detecting at least one touched position of a touch operation executed by a user on the capacitive touch panel including a plurality of sensing elements, comprising:
a first detecting module for detecting the plurality of sensing elements of the capacitive touch panel to generate a plurality of first detecting signals correspondingly;
a judging module coupled to the first detecting module for generating a plurality of judging signals according to the plurality of first detecting signals;
a second detecting module coupled to the judging module and the capacitive touch panel for detecting at least one sensing element of the plurality of sensing elements according to the plurality of judging signals to generate at least one second detecting signal; and
a determining module coupled to the second detecting module for determining the at least one touched position of the touch operation executed by the user on the capacitive touch panel according to the at least one second detecting signal.

2. The detecting apparatus of a capacitive touch panel of claim 1, wherein the judging module judges which of the plurality of sensing elements has been touched by the user according to the plurality of first detecting signals and generates a plurality of judging signals according to judged results correspondingly, and the second detecting module detects the at least one sensing element touched by the user according to the plurality of judging signals to generate the at least one second detecting signal.

3. The detecting apparatus of a capacitive touch panel of claim 1, wherein the plurality of sensing elements includes a first sensing element set and a second sensing element set, and the first detecting module detects the first sensing element set or the second sensing element set to generate the plurality of first detecting signals.

4. The detecting apparatus of a capacitive touch panel of claim 3, wherein the second detecting module detects the first sensing element set and the second sensing element set to generate the at least one second detecting signal.

5. The detecting apparatus of a capacitive touch panel of claim 3, wherein the first sensing element set is interlaced to the second sensing element set.

6. The detecting apparatus of a capacitive touch panel of claim 5, wherein the first sensing element set is perpendicular to the second sensing element set approximately.

7. A detecting method of a capacitive touch panel for detecting at least one touched position of a touch operation executed by a user on the capacitive touch panel including a plurality of sensing elements, which comprising following steps:
(a) detecting the plurality of sensing elements of the capacitive touch panel to generate a plurality of first detecting signals correspondingly;
(b) generating a plurality of judging signals according to the plurality of first detecting signals;
(c) detecting at least one sensing element of the plurality of sensing elements according to the plurality of judging signals to generate at least one second detecting signal; and
(d) determining the at least one touched position of the capacitive touch panel of the touch operation executed by the user on the capacitive touch panel according to the at least one second detecting signal.

8. The detecting method of a capacitive touch panel of claim 7, wherein the step (b) judges which of the plurality of sensing elements has been touched by the user according to the plurality of first detecting signals and generates a plurality of judging signals according to judged results correspondingly, and the step (c) detects the at least one sensing element touched by the user according to the plurality of judging signals to generate the at least one second detecting signal.

9. The detecting method of a capacitive touch panel of claim 7, wherein the plurality of sensing elements includes a first sensing element set and a second sensing element set, and the step (a) detects one of the first sensing element set and the second sensing element set to generate the plurality of first detecting signals.

10. The detecting method of a capacitive touch panel of claim 9, wherein the step (c) detects the first sensing element set and the second sensing element set to generate the at least one second detecting signal.

11. The detecting method of a capacitive touch panel of claim 9, wherein the first sensing element set is interlaced to the second sensing element set.

12. The detecting method of a capacitive touch panel of claim 11, wherein the first sensing element set is perpendicular to the second sensing element set approximately.
